(19) United States
(12) Patent Application Publication
(10) Pub. No.: US 2009/0023885 A1
(43) Pub. Date: Jan. 22, 2009

(54) TREATMENT METHOD FOR IMPARTING HIGH IMPACT RESISTANCE IN CERTAIN CBDO COPOLYMERS

(75) Inventors: Gary W. Beall, San Marcos, TX (US); Jesse R. Hancock, Austin, TX (US); Chad J. Booth, San Marcos, TX (US)

Correspondence Address: Matheson/ Keys PLLC, 7004 Bee Cave Rd., Austin, TX, 78746, US

(73) Assignee: Texas State University - San Marcos, San Marcos, TX (US)

(21) Appl. No.: 12/173,314

(22) Filed: Jul. 15, 2008

Related U.S. Application Data
(60) Provisional application No. 60/959,509, filed on Jul. 16, 2007.

(51) Int. Cl. C08G 63/16

(52) U.S. Cl. 528/302

(57) ABSTRACT

According to the invention, an amorphous CBDO copolymer (as described in U.S. Pat. No. 5,705,575, issued Jan. 6, 1998, which U.S. patent is incorporated herein by reference in its entirety) is treated to impart high impact resistance, also called impact strength.

### CROSS-REFERENCE TO RELATED APPLICATIONS

This application claims priority pursuant to 35 U.S.C. 119 to provisional U.S. Patent Application Ser. No. 60/959,509 entitled “RAPID QUENCHING TO INCREASE IMPACT RESISTANCE IN CBDO COPOLYMERS,” filed Jul. 16, 2007.

Commonly assigned US Application Docket No. 3031-P001US filed on even date herewith also relates to relates to amorphous polyester copolymers compositions.

This application hereby incorporates by reference U.S. Pat. No. 5,705,575, issued Jan. 6, 1998, in its entirety.

### GOVERNMENT LICENSE

The U.S. Government has a paid-up license in this invention and the right in limited circumstances to require the patent owner to license others on reasonable terms as provided for by the terms of Contract No. NAVAIR N68335-07-C-0040 awarded by the United States Naval Air Systems Command.

### REFERENCES CITED

This application hereby incorporates by reference the following U.S. patents:

| Patent No. | Issue Date | Title |
|---|---|---|
| 7,368,511B2 | May 6, 2008 | Polymer Blends With Improved |
| | | Rheology and Improved Unnotched |
| | | Impact Strength |
| 7,354,653 B2 | Apr. 8, 2008 | High Clarity Films With Improved |
| | | Thermal Properties |
| 7,297,755 B2 | Nov. 20, 2007 | Shaped Articles from Cycloaliphatic |
| | | Polyester Compositions |
| 6,986,864 B2 | Jan. 17, 2006 | Polyester Compositions |
| 6,183,848 | Feb. 6, 2001 | Low Melt Viscosity Amorphous |
| | | Copolyesters with Enhanced Glass |
| | | Transition Temperatures Having |
| | | Improved Gas Barrier Properties |
| 5,989,663 | Nov. 23, 1999 | Blow-molding Polyesters From |
| | | Terephthalic Acid, 2,2,4,4-tetra- |
| | | methyl-1,3-cyclobutanediol, And |
| | | Ethylene Glycol |
| 5,705,575 | Jan. 6, 1998 | Copolyester Composition |
| 5,296,587 | Mar. 22, 1994 | Copolymerization of Dicarboxylic |
| | | Acids And Dialkyl Esters of |
| | | Dicarboxylic Acids To Form Polyesters |

This application hereby incorporates by reference the following U.S. patent application Publications:

| Patent No. | Publication Date | |
|---|---|---|
| 2007/0100122 | May 3, 2007 | Polyester Compositions Containing |
| | | Cyclobutanediol and Articles Made |
| | | Therefrom |
| 2007/0010650 | Jan. 11, 2007 | Tough Amorphous Polyester |
| | | Compositions |
| 2006/0293495 | Dec. 28, 2006 | Polyester Compositions Containing |
| | | Cyclobutanediol Having a Certain |
| | | Combination Of Inherent Viscosity |
| | | and Moderate Glass Transition |
| | | Temperature and Articles Made |
| | | Therefrom |
| 2005/0154147 | Jul. 14, 2005 | Polyester Compositions |

This application hereby incorporates by reference the following foreign patent applications:

| Publication | Publication | |
|---|---|---|
| No. | Date | Title |
| WO 9713799 | Apr. 17, 1997 | Orientable, Heat Setable Semi- |
| | | Crystalline Copolyesters |
| WO 8302621 | Aug. 4, 1983 | Copolyesters Comprising Terephthalic |
| | | Acid And 1,4-butane Diol Moieties |
| EP 0745628 | Apr. 12, 1996 | Copolyester Composition |
| EP 0463246 | Jan. 2, 1992 | Aromatic Copolyester. |
| EP 0029285 | May 27, 1981 | Fast Crystallising Block Copolyester |
| | | Composition |

Publications of interest:

| Author | Title/Publication |
|---|---|
| Booth, Chad J. et al | Copolyterephthalates containing |
| | tetramethylcyclobutane with impact |
| | and ballistic properties greater |
| | than bisphenol A polycarbonate, |
| | Polymer, Volume 47, Issue 18, |
| | Aug. 23, 2006, pp. 6398-6405. |
| Behl, Marc et al. | Shape-memory Polymers, Materials |
| | Today, April 2007, Volume 10, |
| | No. 4, pp. 20-28. |
| Beall, Gary W. et al | Physical properties of CBDO based |
| | copolyterephthalate nanocomposites, |
| | Applied Clay Science, Volume 37, Issues |
| | 3-4, September 2007, pp. 295-306. |
| Londa, Dr. Michelle | Nanocomposites: New Materials and New |
| | Paradigms, Nanotechnology Colloquium |
| | presentation and video conference, Jan. 22, 2007, |
| | http://www.nanotxstate.org/20070122_event.htm |

### BACKGROUND OF THE INVENTION

This invention relates to amorphous copolyester copolymer compositions, as disclosed in U.S. Pat. No. 5,705,575, which inherently have a superior impact resistance. There is a need for such materials having an even greater impact resistance, and this invention is a treatment method for imparting superior impact resistance to said amorphous copolyester copolymers (hereinafter referred to as CBDO copolymers).

### BRIEF DESCRIPTION OF THE INVENTION

A method has been discovered for treating amorphous CBDO copolymers which comprises heating said CBDO copolymer to a temperature above its glass transition temperature and then cooling it to a temperature below its glass transition temperature at a cooling rate fast enough to impart high impact strength. The resulting CBDO copolymer exhibits high impact properties to the polymer as described in U.S. Pat. No. 5,705,575 incorporated, herein, by reference above.

### DETAILED DESCRIPTION OF THE INVENTION

Applicants have discovered that compositions made according to the U.S. Pat. No. 5,705,575 will be imparted high impact resistance (impact strength) by a heating/cooling treatment which involves heating the CBDO copolymer to a temperature above its glass transition temperature and then cooling it rapidly to a temperature below its glass transition temperature. This is unexpected, since conventional wisdom in the polymer field is that rapid cooling of polymers produces stress points that lower impact and toughness and annealing slowly relieves these stresses and improves impact and toughness. This discovery came about as follows.

The terms “high” and “low” impact strength (resistance) are relative terms. In the examples herein, high is about 900 j/m and low is about 90 j/m. Thus, amorphous CBDO copolymers of various impact strengths can be made to suit the end use of the treated product.

Applicants needed sheets of the material of U.S. Pat. No. 5,705,575 (hereinafter “the material”). A supplier made the material following the instructions of the applicants. In order to form sheets, the supplier heated the material to above its Tg, and extruded it through a temperature controlled injection molding machine and then between water cooled calendaring rollers. The impact resistance of the sheet was about 900 j/m.

Applicants used a laboratory injection molding machine without temperature controls to form various parts from the pellets that were from the same batch of polymer as the sheet material and noticed differences in physical properties of the parts formed by the laboratory apparatus. Applicants assumed the anomalies were due to lack of temperature control on the mold since it was the one uncontrollable variable.

To test their assumption, applicants treated several samples of the material as follows: The samples were heated in the same oven to a temperature above their Tg. Some of the heated samples were then quenched in an ice/water bath and the other heated samples were cooled overnight in the oven which was turned off.

Testing the samples for impact resistance gave a surprising result. The quenched samples gave an impact resistance ten times higher than the slowly cooled samples. The prior art teaches that just the opposite should have occurred.

In general, according to this discovery, fast cooling rates result in high impact resistance values. Conversely, slow cooling rates do not impart a high impact resistance. The examples below illustrate this.

Also, it has been discovered that the cis:trans isomer content of the CBDO copolymer product affects the resulting impact resistance as well. As the examples below will show, applicants tested two materials made according to the U.S. Pat. No. 5,705,575. In one, the cis:trans isomer ratio was 46/54 percent. Another had a cis:trans isomer ratio of 18/82 percent.

The examples clearly show that the superior impact resistance was obtained when the cooling rate was fast, as opposed to slow. The examples also show that superior impact resistance was obtainable when the cis isomer was present in larger amounts. The useful copolymers of the invention are those wherein the cis isomer is present in an amount effective to yield a high impact resistance when treated similarly to Examples 1-4. This amount of cis isomer is referred to as “an effective amount of cis isomer.”

The CBDO copolymer described in U.S. Pat. No. 5,705,575 has been studied extensively in our laboratories. As described above, this work has discovered unexpected effects of processing history on the ultimate impact resistance that are counter to the prior art. In most cases, in the prior art, if polymers are annealed to temperatures above their glass temperatures and then slowly cooled, the impact strength increases. It has been discovered that exactly the opposite occurs with CBDO copolymers of U.S. Pat. No. 5,705,575. These copolymers exhibit much higher impact resistance when cooled rapidly from a temperature above the glass transition temperature, as opposed to those which are cooled slowly. The examples below will illustrate this discovery.

### EXAMPLE 1

¹Seven notched Izod bars of a CBDO copolymer containing 40 mole % of 2,2,4,4 tetramethyl 1,3 cyclobutanediol and 60 mole % of 1,3 propanediol with terephthalic acid was placed in an oven at 110° C. for 12 hours and then cooled back to room temperature over a twelve hour period. The average notched Izod impact strength of these samples yielded a value of 90 j/m. ¹Examples 1 through 6 had a cis:trans isomer ratio of about 46/54 percent.

### EXAMPLE 2

Seven other notched Izod samples of the polymer described in example 1 were heated for 12 hours in the same oven. The samples were then removed from the oven and quenched in an ice/water bath. These samples were tested for their impact strength and yielded an average value of 940 j/m.

### EXAMPLE 3

The CBDO copolymer with a glass transition temperature of about 85° C. was cooled at about 8° C. per minute from 100 to 80° C. The resulting material had a high impact resistance.

### EXAMPLE 4

The CBDO copolymer was cooled as in example 3 at the rate of 15° C. per minute and also had a high impact resistance.

### EXAMPLE 5

The same CBDO copolymer material was cooled from 100 to 80° C. at 0.5° C. per minute and exhibited low impact strength.

### EXAMPLE 6

The CBDO copolymer was cooled from 100 to 80° C. at 0.001° C. per minute. The sample had a low impact resistance.

### EXAMPLE 7

A CBDO copolymer with a cis:trans isomer ratio of about 18:82 percent was treated as in Example 2. The treated sample had low impact strength.

What is claimed is:

1. A method for treating an amorphous CBDO copolymer containing an effective amount of cis isomer comprising heating said copolymer to a temperature above its glass transition temperature and then cooling it to a temperature below its glass transition temperature at a cooling rate fast enough to impart a high impact strength.

2. A method as in claim 1, wherein the copolymer is cooled at a rate enough greater than about 0.5° C. per minute to impart a high impact strength.

3. A method as in claim 1, wherein the cooling rate is about 8° C. per minute.

4. A method as in claim 1, wherein the cooling rate is about 15° C. per minute.

5. A method as in claim 1, wherein cooling is effected by quenching in an ice water bath.

6. A method as in claim 1, wherein the cis isomer is present in an amount enough greater than about eighteen percent to impart a high impact strength.

7. A method as in claim 1, wherein the cis isomer is present in at least an amount of about forty six percent or greater.

8. A method for treating an amorphous CBDO copolymer containing an effective amount of cis isomer comprising heating said copolymer to a temperature above its glass transition temperature and then cooling it to a temperature below its glass transition temperature by quenching it in an ice water bath.

9. A method for treating an amorphous CBDO copolymer containing an effective amount of cis isomer comprising heating said copolymer to a temperature above its glass transition temperature and then cooling it to a temperature below its glass transition temperature at a rate enough greater than about 0.5° C. per minute to impart a high impact strength.

10. A method for treating an amorphous CBDO copolymer comprising heating said copolymer to a temperature above its glass transition temperature and then cooling it to a temperature below its glass transition temperature at a cooling rate fast enough to impart a high impact strength, wherein the cis isomer is present in an amount enough greater than about eighteen percent to be effective to impart high impact strength.
